(19) United States
(12) Patent Application Publication
(10) Pub. No.: US 2007/0174437 A1
(43) Pub. Date: Jul. 26, 2007

(54) Method for managing and monitoring the operation of a plurality of distributed hardware and/or software systems that are integrated into at least one communications network, and system for carrying out the method

(75) Inventor: Rudi Kraus, Ellerstadt (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, MUNCHEN (DE)

(21) Appl. No.: 10/591,790

(22) PCT Filed: Mar. 1, 2005
(86) PCT No.: PCT/EP05/50889

§ 371 Date: Dec. 11, 2006

(30) Foreign Application Priority Data
Mar. 4, 2004 (DE) 10 2004 011 201.0

(51) Int. Cl. G06F 15/173

(52) U.S. Cl. 709/223

(57) ABSTRACT

A method for managing and monitoring the operation of several distributed hardware and/or software systems that are integrated into at least one communications network. A central programming element, which is stored in a data processing device, processes system-related data that are contained in the data processing device or that have been received by the device via a communications network. The programming element then autonomously derives operation-related decisions from the data and, based on the decisions, generates decision-specific control data to influence the operation of one or more hardware and/or software systems. The element subsequently transmits the control data to data processing devices that are assigned to the respective hardware and/or software systems.

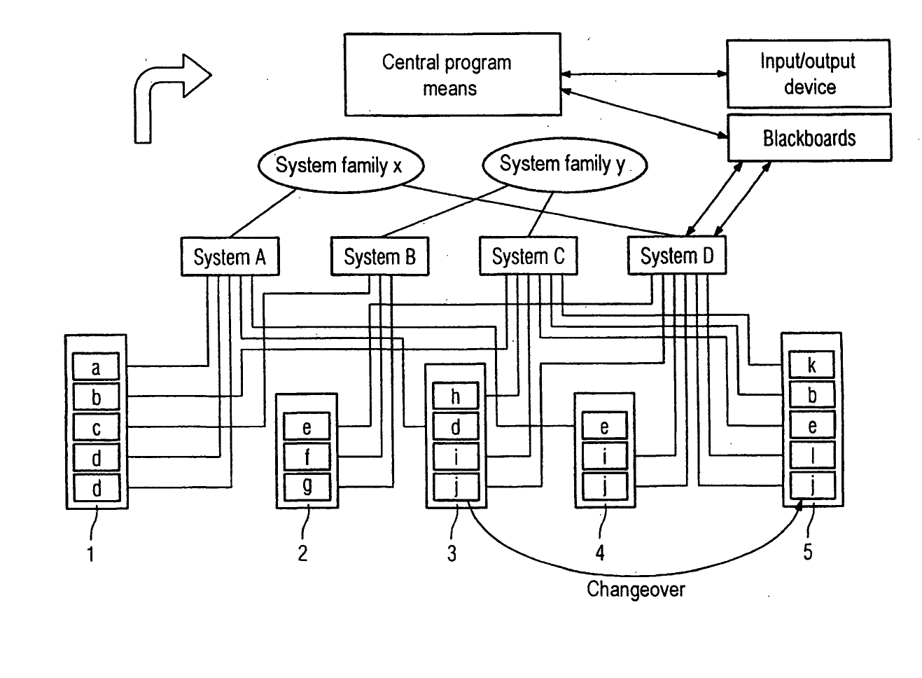

Method for managing and monitoring the operation of a plurality of distributed hardware and/or software systems that are integrated into at least one communications network, and system for carrying out the method

The invention relates to a method for managing and monitoring the operation of a plurality of distributed hardware and/or software systems that are integrated into at least one communications network.

For reasons of cost and efficiency, more and more distributed hardware and/or software systems have recently been used in the business sector, in particular. Such systems can be operated in a virtual environment using the possibilities of “adaptive computing” in which, in a development of conventional systems, adaptation to the requirements of the current application is also possible in the hardware. Software systems which are becoming ever more complex are being operated in an increasingly heterogeneous hardware world. The assignment between software entities and hardware resources is no longer fixed but varies dynamically depending on the current requirements.

It is not possible to manage and monitor such distributed hardware environments using the conventional tools and monitoring tools which presuppose a fixed assignment between hardware and software. On account of the continuous dynamic configuration changes in the systems, which result, for example, from the self-healing mechanisms implemented by the system, the administrator's purely manual way of working is hardly practical any more.

Therefore, the invention is based on the object of specifying an improved method for managing and monitoring the operation of a plurality of distributed hardware and/or software systems.

In order to achieve this object, a method of the type mentioned initially provides, according to the invention, for a central program means that is stored in a data processing device to process system-related data which are present in the data processing device or are received by the latter via a communications network, to autonomously derive operation-related decisions from said data and, on the basis of said decisions, to generate decision-specific control data for influencing the operation of one or more hardware and/or software systems and to transmit said control data, via the communications network, to data processing devices which are assigned to the respective hardware and/or software systems.

The central program means is thus capable of automatically and autonomously carrying out essential management, administration and monitoring tasks. It combines capabilities and functions which can nowadays be furnished only in part by administrators and system management and monitoring tools and which have hitherto not been able to be sufficiently furnished in the field of “adaptive computing”. An important basis of the method according to the invention is the decision-making component of the central autonomous program means. Control data are generated on the basis of the decisions made in this manner and are forwarded to the individual systems which, for example, stop a hardware and/or software system or move a particular application. The control data are transmitted, via the communications network, to the individual systems which are affected by the respective decisions. In this manner, in the method according to the invention, the central program means undertakes numerous tasks which, in conventional hardware and software environments, are manually undertaken by administrators.

One development of the concept of the invention provides for the central program means to access rule data, which comprise, in particular, rules regarding priorities and/or sequences and/or logical and/or temporal relationships, and/or performance data, which relate, in particular, to the current operational load and/or the temporally restricted and/or dynamic and/or periodically needed capacity requirement, and/or grouping data and/or classification data and/or availability data, said data being stored in the data processing device. The rule data form a rule system which prescribes a basic structure for the management or administration and monitoring method. Priority rules may define, for example, the preference for the interactive mode over batch processing in an application entity. Sequences may determine which services have to be stopped first in the event of a stoppage. System components possibly have to resort to other systems or results provided by other system components. In such cases, it is necessary to take into account a number of logical and/or temporal relationships that the method obtains from the rule data. A software system requires sufficient hardware resources. In order to determine the capacities required and the regular operational load on the hardware systems, the performance data can again be accessed in the method according to the invention. Performance data relate, for example, to the current operational load or the capacity regularly required by an application that runs at certain intervals of time, for example. Said data provide a measure of the performance of the system environment. For effective management, it is also expedient to divide the system environment, together with its components and the tasks to be carried out by it, into different groups or classes. The associated grouping and classification data may correspondingly relate to structural aspects (for example in the case of identical hardware) and aspects as regards contents (for example in the case of components which interact in order to solve a problem). In addition, the method accesses data relating to the availability of individual systems. For example, the method thus determines whether and where the resources, for example CPUs or main memories, needed for an application that is running according to plan are available.

In addition, the invention provides for the system-related data to be operating plans, which regulate, in particular, run times and availability of individual hardware and/or software systems, and/or information regarding the operating state of individual systems, said information relating, in particular, to the current and/or future and/or periodic workload, and/or an operator's wishes which have been input at the central and/or individual system level using an input device. In contrast to the data mentioned in the preceding section, these system-related data are of a less general nature but rather relate more to the current operation of the systems. In this case, the central program means receives, for example, data regarding the fact that an application which accesses a database that is currently greatly burdened is currently running. If there is then a fault in an application entity and in a database entity required by the latter, the central program means can use these system-related data to access the rule data which comprise, for example, the fact that, in such a case, the fault in the database entity must be rectified first. In this case, it is necessary to take into account operator wishes, which a user can input at the central and/or individual system level using an input device, in order to ensure ease of operation and to enable variable operation.

The central data processing device expediently receives the information regarding the operating state of individual systems in an active and/or passive manner. The task of receiving and collecting the information can thus be adapted depending on the conditions of the system environment. For example, it may be advantageous for the central data processing device to be provided, as standard, with routine data associated with normal operation, while it independently actively requests special data in the case of faults or reconfiguration problems, for example.

The invention provides for the information to relate to hardware in the form of clients and/or servers and/or networks and/or storage systems and/or software in the form of applications and/or distributed applications having services that are dependent on one another and/or distributed application systems having virtualized services that are dependent on one another and/or are independent of one another and/or databases and/or front ends. More or less system-related information regarding the hardware and software is required depending on the design of the underlying system environment. Server/client networks and storage units or storage systems are given an outstanding role in connected system environments. Databases are usually accessed from a plurality of systems, so that the information relating to the latter should be centrally available. The same applies to distributed application systems, in particular in the field of “adaptive computing”, since in this case configuration changes have to be centrally monitored.

Provision is expediently made for the control data which are generated by the central program means to control the starting and/or stopping and/or addition of services and/or the movement of services and/or applications and/or the maintenance of a distributed hardware and/or software system. In this manner, the central program means causes an application to be started or a hardware system to be stopped, for example. Individual services, for example interactive mode, batch processing, accounting, printing, messaging or a web service, can be added or, if they are no longer needed again or are needed again only after a particular period of time has elapsed, can be moved. Applications which are currently not required can similarly be moved. Maintenance, for example when installing and updating applications, can be centrally controlled in an analogous manner. Applications can thus be installed autonomously and centrally on the basis of the acknowledgments which are received in the individual updating and installation steps. If an application environment is to be stopped again, the decision-specific control data are based, as when starting, on a sequence and alternative routines are heeded. It is also possible to reconfigure a software system, for example, in a similar manner.

One refinement of the invention provides for the operation-related decisions to comprise the determination of administrative tasks and/or chains of tasks. A task may be, for example, the monitoring of a particular system. Chains of tasks comprise tasks that are to be executed in a particular order, for example the coordinated stopping of a plurality of systems.

Provision is also made for the central program means to autonomously separate administrative tasks and/or chains of tasks into subtasks taking into account logical and/or temporal relationships and/or dynamic influences and/or availability data and/or priorities and/or grouping data and/or classification data and/or application data which are present in the data processing device, in particular for the purpose of moving and/or replacing application entities. If, for example, it is necessary to reconfigure a system environment, a chain of a large number of tasks needs to be executed for this purpose. An application whose functionality is based on a database can only be operated again after the database on account of the logical relationship. Temporal relationships exist if, for example, it is necessary to resort to earlier results. In addition, it may be expedient to only operate system entities of a particular class again in order to establish a basic functionality, for example. In this case, separation into subtasks makes it possible to execute chains of tasks in a locally distributed manner and to take into account temporal conditions.

It is also advantageous if the central program means checks the temporal progression of the administrative tasks and/or chains of tasks, which are transmitted to the individual hardware and/or software systems in the form of control data, continuously and/or at particular intervals of time. In this manner, faults and problems which possibly arise are discovered as a matter of routine in the course of operation. If necessary, the execution of a chain of tasks can be interrupted. However, variable reactions to the faults and problems, which go beyond interruption, are also possible on the basis of the available rule and performance data.

One development of the invention provides for at least some of the distributed hardware and/or software systems to be assigned their own autonomous program means which are stored in data processing devices and are in the form of autonomous agents which are subordinate to the central program means. In this case, the autonomous program means or agents at the system level carry out administrative and monitoring tasks but they are subordinate to the central program means so that it is possible to avoid collisions in decisions which affect a plurality of systems in the system environment.

Provision is also made for the autonomous agent of an individual hardware and/or software system to access rule data which are prescribed at the system level in the data processing devices and comprise, in particular, rules for the individual system and/or the interaction with the central autonomous program means. Depending on the stipulation of these rules, the autonomous agent makes decisions for his respective system on the basis of the rules insofar as said decisions do not fall within the regulating sphere of the central autonomous program means. If the autonomous agent cooperates with the central autonomous program means, this cooperation is again subject to rules so that, for example, both do not make operation-related decisions, which differ from one another under certain circumstances, for the same area of the system.

The central program means and the autonomous agents of the individual hardware and/or software systems expediently interchange control and/or rule data via the communications networks. In this manner, the central program means receives information regarding control processes which have been carried out at the system level, for example the movement of a service, and may coordinate the central management and administration therewith. Conversely, the autonomous agent at the system level requires information regarding the operations in which the central program means has intervened in the system in order to avoid collisions or to prevent individual tasks from being processed twice.

It is advantageous if the central program means grants decision-making powers to the autonomous agents of the individual systems, and/or withdraws said decision-making powers, in a permanent or temporally restricted and/or dynamic manner using the communications networks. Such dynamic authorization makes it possible to react to changes in the system environment in a flexible manner. In the event of a fault, it is expedient, for example, for the central program means to be granted greater decision-making powers in order to first restore basic operation. In contrast, in the case of trouble-free operation, the decision-making powers of the autonomous agents can be increased if no problems are to be expected.

The invention provides for the autonomous agents of the individual hardware and/or software systems to respectively transmit general and/or system-specific control data to the data processing device of the central program means via a communications network and/or to publish said data in generally accessible file systems and/or to collaborate in the separation of administrative tasks and/or chains of tasks into subtasks. The term publication means that data which are of interest beyond individual system levels are made available to the central program means or else to other subsystems using a generally accessible file system (blackboard). Separating the tasks at the individual system level eases the burden on the central program means and dividing the tasks into subtasks at the individual system level is also more expedient in specific systems.

One development of the invention provides for the central program means to be operated in different operating modes, in particular in a fully autonomous or partially autonomous manner and/or with different reaction speeds. These different operating modes can be selected depending on the current operating conditions. Simple standard operation can be carried out in a fully autonomous manner but partially autonomous operation will generally be expedient in the event of faults. The speed at which the means react to a given situation needs to be orientated to all of the operations which take place in the system environment. In the individual case, a slow reaction may be expedient in order to conclude a particular operation before the reaction. In the case of relatively great problems, it is often necessary to react quickly in order to prevent a chain of resultant problems.

Provision is expediently made for the operation of the central program means in the partially autonomous mode to be changed and/or interrupted by manual inputs on an input device by an authorized administrator. This ensures that, in the case of rare problems or faults or else special operating requirements for which there are no rules under certain circumstances, operation can still be controlled manually.

In addition, it may be expedient for the operation of the central program means in the partially autonomous mode to be changed and/or interrupted by the autonomous agents of the individual systems. Such a restriction of the autonomous operation of the central program means is expedient when the autonomous agents at the individual system level are working on their system in a comparatively independent manner without interchanging a relatively large amount of data with the central program means, with the result that, in the event of a fault, the central program means may be lacking information which the autonomous agent has and which renders it necessary to change the central operation. The autonomous agent can then arrange for this change to be made.

It is advantageous if the central program means comprises a notification component which uses an output device to output information regarding substeps of the work of the central program means and/or the processing state thereof. An administrator or operator thus receives information regarding the progression of system operation and accordingly knows, for example, when tasks whose results he requires will be concluded. In addition, the administrator can coordinate any possible planned manual interventions with the given processing state. Malfunctions can be quickly detected.

One refinement provides for the distributed hardware and/or software systems to comprise at least one application system. The at least one application system may comprise a plurality of entities which each control at least one service, in particular interactive mode and/or batch mode and/or accounting and/or printing and/or messaging and/or network services. Messaging services make it possible to communicate and interchange notifications, while network services are responsible, on the one hand, for internal networks and, on the other hand, for the connection to principally external networks such as the Internet, for example in the form of web services. The different entities of an application form a logical system with corresponding relationships.

Provision is also made for a plurality of application systems to cooperate in a system family. This constellation is typical of relatively large configurations, in which a number of relationships can again exist between the individual systems if, for example, application systems are placed on one another or condition one another.

In addition, it is possible for at least one application system to be operated in a virtual environment without fixed hardware assignment. The use of the method according to the invention using the central autonomous program means is particularly advantageous, in particular, in such a case if the assignment between the application and the hardware varies and cannot be readily identified from the outside since conventional management and administration methods provide only insufficient and complicated solutions in this case.

Provision is also made for the distributed hardware and/or software systems to comprise client/server systems and/or operating systems. Client/server systems are of central importance in modern computer environments. This applies, in particular, in “adaptive computing”. The corresponding operating systems form the connection to the application systems.

In addition, the invention relates to a system for managing and monitoring the operation of a plurality of distributed hardware and/or software systems that are integrated into at least one communications network, said system comprising a data processing device and a central autonomous program means that is stored in the latter and/or autonomous agents (which are stored in data processing devices) for individual hardware and/or software systems and/or input and/or output devices at the central and/or individual system level and being designed to carry out the method as described above.

Further advantages, features and details of the invention will be described below with reference to a particularly suitable exemplary embodiment.

The figure shows a schematic diagram for carrying out the method according to the invention.

The central program means is stored in a data processing device which is not illustrated here. There is a connection to an input/output device. In this case, an operator or administrator can effect inputs, for example in order to change or interrupt the operation of a central program means that is operating in the partially autonomous mode, or can follow up the notifications from the central program means regarding the substeps of the work and the processing state of the latter. Two system families x and y which comprise, for example, cooperating applications are subordinate to the central program means. Each of the two system families comprises two subsystems, the systems A and D and B and C.

The central program means and the individual systems are each mutually related to the blackboards (generally accessible file systems). The individual systems publish, if appropriate, general and/or system-specific control data, which are not only intended to be accessible to the central program means but also to further individual systems, on the blackboards using their autonomous agents, in particular. This is interesting when the data can affect other systems, for example when applications mutually depend on one another. The individual systems, for their part, provide the central program means with control and rule data via communications networks. In addition, they collaborate in the separation of administrative tasks or chains of tasks into subtasks.

The systems A-D are responsible for different services a-l. These services may comprise, for example, interactive or batch processing, accounting, printing, messaging and web services. The systems are operated in a distributed manner, with the result that the services associated with a system are respectively implemented in different autonomous individual systems. In the case illustrated, these individual systems are autonomous hardware systems 1-5 which are composed of heterogeneous hardware components. Each system is provided with individual hardware and an operating system (not illustrated here). The services a and d of the system A run on the autonomous individual system 1 and the service d is simultaneously also operated in the individual system 3, while a further service e of the system A is located in the individual system 4. This assignment of the services of the systems A-D to the individual systems 1-5 varies dynamically depending on the current requirements of the overall system environment. There is no fixed assignment between the application and the hardware resources. For example, the service j, which belongs to the application system D and is initially running on the autonomous individual system 3, is changed over to operation in the autonomous individual system 5.

The autonomous agents of the individual systems and the central program means collect and process information regarding operation taking into account the changing assignments and derive autonomous decisions from said information. Since the individual systems A-D, for their part, have the autonomous powers (not illustrated here), the amount of information that needs to be interchanged overall in the system environment is reduced and a multiplicity of reaction possibilities which can each be attributed to simple reactions are produced. The central program means can be operated in a fully autonomous or partially autonomous manner. In the partially autonomous mode, the operation of the central program means can be changed or interrupted by inputs by an administrator on the input/output device or by the autonomous agents of the individual systems. Since there is no fixed assignment between the hardware and software, it is possible to utilize and make full use of the hardware resources in an optimum manner. As illustrated here, the same services may run on different autonomous individual systems. For example, the service e can be operated in the individual systems 2, 4 and 5. If one of these systems is particularly burdened, the application system which is responsible for this service, for example, can alternatively allow the service to run on another hardware system. The central program means also enables effective management and effective monitoring and administration in such a case of “adaptive computing” having virtual environments.

1-24. (canceled)

25. A method for managing and monitoring an operation of a plurality of distributed hardware and/or software systems that are integrated into at least one communications network, the method which comprises:
with a central program means stored in a data processing device, processing system-related data that are present in the data processing device or are received by the data processing device via a communications network;
autonomously deriving operation-related decisions from the data;
based on the decisions, generating decision-specific control data for influencing the operation of one or more hardware and/or software systems; and
transmitting the control data, via the communications network, to data processing devices assigned to the respective hardware and/or software systems.

26. The method according to claim 25, wherein the central program means accesses at least one set of data stored in the data processing device and selected from the group consisting of rule data, performance data, grouping data, classification data, and availability data.

27. The method according to claim 26, wherein the rule data comprise rules regarding priorities and/or sequences and/or logical and/or temporal relationships, and the performance data relate to a current operational load and/or a temporally restricted and/or dynamic and/or periodically needed capacity requirement.

28. The method according to claim 25, wherein the system-related data are selected from the group consisting of operating plans, information regarding operating states of individual systems, and operator's wishes having been input at a central and/or individual system level using an input device.

29. The method according to claim 25, wherein the operating plans regulate run times and availability of individual hardware and/or software systems, and the information regarding the operating state of individual systems relate to a current and/or future and/or periodic workload.

30. The method according to claim 29, which comprises receiving, with the central data processing device, the information regarding the operating state of individual systems in an active and/or passive manner.

31. The method according to claim 29, wherein the information relates to hardware selected from the group of clients, servers, networks, and storage systems, and/or to software selected from the group of applications, distributed applications having services that are dependent on one another, distributed application systems having virtualized services that are dependent on one another and/or independent of one another, and/or databases, and/or front ends.

32. The method according to claim 25, wherein the control data are configured to control at least one operation selected from the group consisting of starting, stopping, and adding services, moving services, moving applications, and maintenance of a distributed hardware and/or software system.

33. The method according to claim 25, wherein the operation-related decisions include determining administrative tasks and/or chains of tasks.

34. The method according to claim 33, which comprises, with the central program means, autonomously separating administrative tasks and/or chains of tasks into subtasks taking into account logical and/or temporal relationships and/or dynamic influences and/or availability data and/or priorities and/or grouping data and/or classification data and/or application data that are present in the data processing device.

35. The method according to claim 33, which comprises, with the central program means, autonomously separating administrative tasks and/or chains of tasks into subtasks for moving and/or replacing application entities.

36. The method according to claim 33, which comprises checking, with the central program means, a temporal progression of the administrative tasks and/or chains of tasks that are transmitted to the individual hardware and/or software systems in the form of control data.

37. The method according to claim 36, which comprises configuring the central program means to check continuously and/or at particular intervals of time.

38. The method according to claim 25, which comprises assigning at least some of the distributed hardware and/or software systems their own autonomous program means that are stored in data processing devices in the form of autonomous agents that are subordinate to the central program means.

39. The method according to claim 38, which comprises accessing, with the autonomous agent of an individual hardware and/or software system, rule data that are prescribed at the system level in the data processing devices.

40. The method according to claim 39, wherein the rule data prescribed at the system level in the data processing devices comprise rules for the individual system and/or the interaction with the central autonomous program means.

41. The method according to claim 39, which comprises interchanging control and/or rule data via the communications networks between the central program means and the autonomous agents of the individual hardware and/or software systems.

42. The method according to claim 39, which comprises, with the central program means, selectively granting decision-making powers to the autonomous agents of the individual systems, and withdrawing the decision-making powers, using the communications networks.

43. The method according to claim 39, which comprises granting and withdrawing the decision-making powers permanently, temporally restricted, or dynamically.

44. The method according to claim 39, wherein the autonomous agents of the individual hardware and/or software systems respectively transmit general and/or system-specific control data to the data processing device of the central program means via a communications network and/or publish the data in generally accessible file systems and/or collaborate in a separation of administrative tasks and/or chains of tasks into subtasks.

45. The method according to claim 25, which comprises operating the central program means in different operating modes.

46. The method according to claim 45, which comprises operating the central program means in at least one operating mode selected from the group consisting of fully autonomous mode, partially autonomous mode, and with different reaction speeds.

47. The method according to claim 45, which comprises operating the central program means in partially autonomous mode and changing and/or interrupting the partially autonomous mode with a manual input on an input device by an authorized administrator.

48. The method according to claim 45, which comprises operating the central program means in partially autonomous mode and changing and/or interrupting the partially autonomous mode by the autonomous agents of the individual systems.

49. The method according to claim 25, wherein the central program means includes a notification component, and the notification component outputs information regarding substeps of the work of the central program means and/or the processing state thereof via an output device.

50. The method according to claim 25, wherein the distributed hardware and/or software systems comprise at least one application system.

51. The method according to claim 50, wherein the at least one application system comprises a plurality of entities each controlling at least one service.

52. The method according to claim 51, wherein the at least one service is selected from the group of interactive mode, batch mode, accounting services, printing services, messaging services, and network services.

53. The method according to claims 51, wherein a plurality of application systems cooperate in a system family.

54. The method according to claim 50, which comprises operating the at least one application system in a virtual environment without fixed hardware assignment.

55. The method according to claim 25, wherein the distributed hardware and/or software systems comprise client/server systems and/or operating systems.

56. A system for managing and monitoring an operation of a plurality of distributed systems selected from the group consisting of hardware systems and software systems integrated into at least one communications network, the system comprising:
a data processing device, and at least one of a central autonomous program means stored in said data processing device and autonomous agents, stored in data processing devices, for individual hardware and/or software systems and/or input and/or output devices at a central system level and/or an individual system level, and configured to carry out the method according to claim 25.
